(19) United States
(12) Patent Application Publication
(10) Pub. No.: US 2021/0215316 A1
(43) Pub. Date: Jul. 15, 2021

(54) LUMINAIRE HAVING EDGE-LIT LIGHT PANEL WITH SUB-SURFACE OPTICAL FEATURES

(71) Applicant: Hubbell Incorporated, Shelton, CT (US)

(72) Inventor: Christopher Bailey, Greenville, SC (US)

(21) Appl. No.: 17/142,520

(22) Filed: Jan. 6, 2021

Related U.S. Application Data
(60) Provisional application No. 62/959,565, filed on Jan. 10, 2020.
(60) Provisional application No. 62/975,492, filed on Feb. 12, 2020.

(51) Int. Cl. F21V 5/08; F21S 8/06

(52) U.S. Cl. CPC F21V 5/08; F21S 13/04; F21S 8/06

(57) ABSTRACT

A luminaire includes a housing, a light diffusion panel, and a light source. The light diffusion panel is positioned in the housing. The light diffusion panel includes a light source aperture defined therein, an edge surface bounding the light source aperture, a plurality of sub-surface optical features disposed within the light diffusion panel, and an emission surface. The emission surface includes an emission surface section. The light source projects light into the light diffusion panel through the edge surface of the light diffusion panel. The light projects into the light diffusion panel to interact with the plurality of sub-surface optical features and exit the light diffusion panel through the emission surface section.

### CROSS-REFERENCE TO RELATED APPLICATIONS

This application claims the benefit of U.S. Provisional Patent Application No. 62/959,565, filed Jan. 10, 2020, and U.S. Provisional Patent Application No. 62/975,492, filed Feb. 12, 2020, which are incorporated by reference herein in their entirety.

### FIELD

Embodiments described herein relate to a luminaire including an edge-lit light guide.

### SUMMARY

The present disclosure relates, in one aspect, to a luminaire including a housing, a light diffusion panel, and a light source. The light diffusion panel is positioned in the housing. The light diffusion panel includes a light source aperture defined therein, an edge surface bounding the light source aperture, a plurality of sub-surface optical features disposed within the light diffusion panel, and an emission surface. The emission surface includes an emission surface section. The light source projects light into the light diffusion panel through the edge surface of the light diffusion panel. The light projects into the light diffusion panel to interact with the plurality of sub-surface optical features and exit the light diffusion panel through the emission surface section.

The present disclosure relates, in another aspect, to a luminaire including a housing, a light diffusion panel, and a light source. The light diffusion panel is positioned in the housing. The light diffusion panel includes a plurality of sub-surface optical features disposed therein, a panel outer periphery, and a panel emission surface. The light source projects light into the light diffusion panel through the panel outer periphery, into one or more of the sub-surface optical features, and out of the light diffusion panel through the panel emission surface.

Other aspects of the embodiments will become apparent by consideration of the detailed description and accompanying drawings.

### BRIEF DESCRIPTION OF THE DRAWINGS

FIG. 1 illustrates a side/bottom perspective view of a luminaire, according to embodiments described herein.

FIG. 2 illustrates a bottom perspective view of the luminaire of FIG. 1.

FIG. 3 illustrates a side perspective view of the luminaire of FIG. 1.

FIG. 4 illustrates a side elevation view of the luminaire of FIG. 1.

FIG. 5 illustrates a top perspective view of the luminaire of FIG. 1.

FIG. 6 illustrates a top plan view of the luminaire of FIG. 1.

FIG. 7 illustrates a bottom plan view of the luminaire of FIG. 1.

FIG. 8 illustrates a top plan view of a light diffusion panel of the luminaire of FIG. 1.

FIG. 9 illustrates a side elevation cross-sectional view of a light diffusion panel undergoing the sub-surface laser engraving process.

FIG. 10 illustrates a partial cross-sectional view of the luminaire of FIG. 1.

FIG. 11 illustrates a side elevation view of light projection patterns of two separate luminaires of the type shown in FIG. 1.

FIG. 12 illustrates a top plan view of a first light projection pattern of FIG. 11.

FIG. 13 illustrates a top plan view of a second light projection pattern of FIG. 11.

FIG. 14 illustrates a detailed cross-sectional elevation view of a portion of a luminaire, according to embodiments described herein.

FIG. 15 illustrates a detailed cross-sectional elevation view of a portion of a luminaire, according to embodiments described herein.

FIG. 16 illustrates a detailed cross-sectional elevation view of a portion of a luminaire, according to embodiments described herein.

FIG. 17 illustrates a cross-sectional elevation view of a luminaire, according to embodiments described herein.

FIG. 18 schematically illustrates a detailed cross-sectional elevation view of light diffusion panels of a luminaire, according to embodiments described herein.

FIG. 19 schematically illustrates a detailed cross-sectional elevation view of light diffusion panels of a luminaire, according to embodiments described herein.

FIG. 20 illustrates a bottom plan view of examples of a luminaire, according to embodiments described herein.

FIG. 21 illustrates an alternative assembly of two light diffusion panels for use with the luminaire of FIG. 1.

FIG. 22 schematically illustrates a cross-sectional view of examples of layouts of light diffusion panels of a luminaire, according to embodiments described herein.

### DETAILED DESCRIPTION

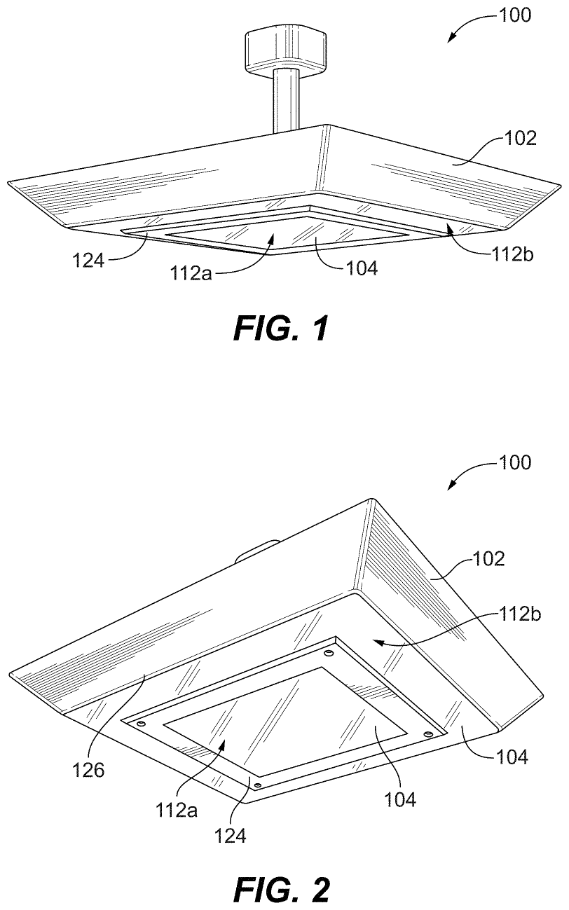

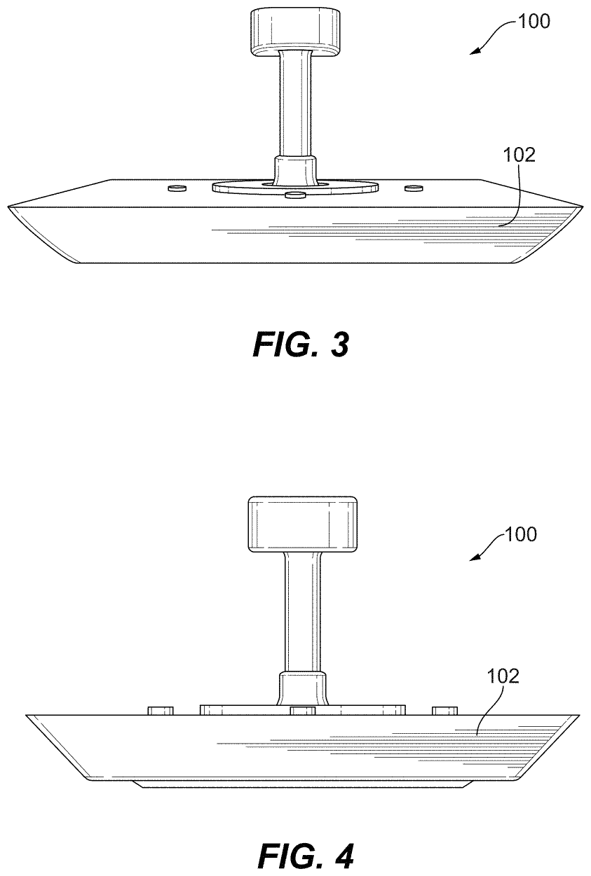

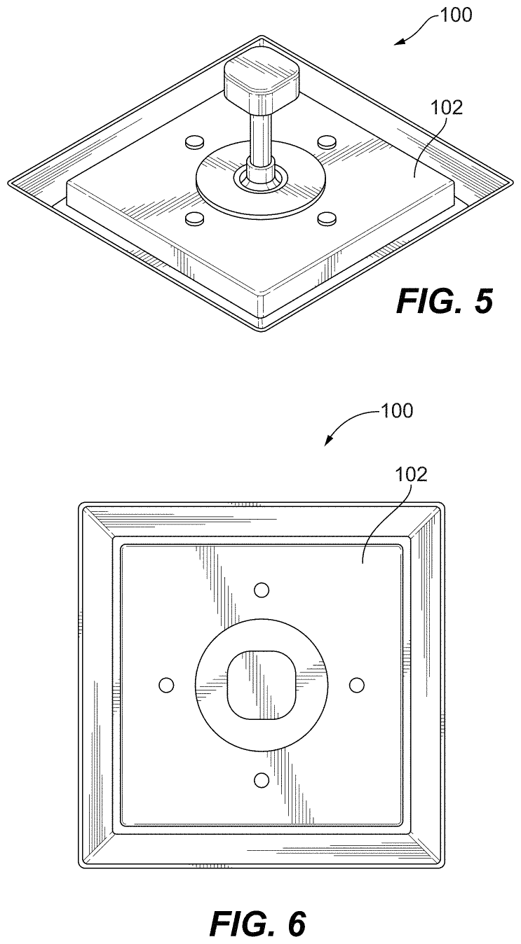

FIGS. 1-7 illustrate a luminaire 100. The luminaire includes a housing 102. The housing 102 can be made of, for example, die-cast aluminum low-copper material. The housing 102 at least partially contains a light diffusion panel 104, which may also be referred to as a light guide or a light guide plate. In some embodiments, the light diffusion panel 104 is a flat or planar structure. In other embodiments, the light diffusion panel 104 may be curved or some other shape. The light diffusion panel 104 can be made of an optically transmissive material such as, for example, clear acrylic.

As shown in FIG. 8, some embodiments of the light diffusion panel 104 include at least one light source aperture 106 (illustrated as white bar sections). The light diffusion panel 104 also includes, in some embodiments, laser-engraved or otherwise manufactured optical features 108. These optical features 108 (which may also be referred to as extraction features) may be in the form of surface treatment (which may also be referred to as surface features) of the light diffusion panel 104, or may be within the light diffusion panel 104. The optical features 108 can form what may be referred to as extraction zones. The optical features 108 can be implemented in a uniform or a non-uniform manner. The optical features 108 may be formed with, for instance, surface or sub-surface laser engraving. The optical features 108 are shown in FIG. 8 as a plurality of dots.

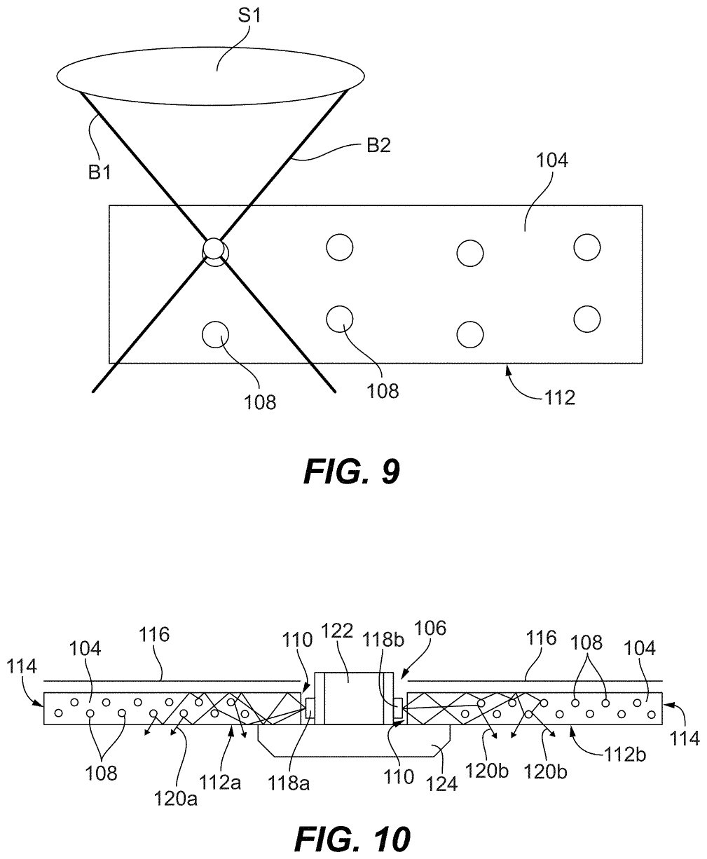

FIG. 9 illustrates the sub-surface laser engraving process. In FIG. 9, the light diffusion panel 104 is exposed to a laser system S1 (such as a sub-surface laser engraving machine) which generates a plurality of three-dimensional sub-surface optical features 108 within the material of the light diffusion panel 104. The sub-surface optical features 108 in aggregate form a design which serves a functional or artistic purpose. Each sub-surface optical feature 108 is generated as a result of interacting beams B1 and B2, for instance, focused to a high intensity at a particular location (focal point) within the light diffusion panel 104. These sub-surface optical features 108 are the result of photonic excitation and an intense heat gradient generated at the focal point of the beams B1, B2. The material of the light diffusion panel 104 outside the focal point of the beams B1, B2 is relatively unchanged and relatively undamaged by the beams B1, B2 traveling through it. In some embodiments, each sub-surface optical feature 108 is in the range of 40 to 80 micrometers in diameter. The size of each sub-surface optical feature 108 may be referred to as the point size.

The use of a sub-surface laser engraving process, in some embodiments, allows for improved production times and precision. The process also allows for sub-surface optical features 108 at different locations in the length direction, width direction, and thickness direction of the light diffusion panel 104, forming a multi-dimensional effect not possible with surface treatment. In some embodiments, this versatility allows for more complex and more effective light diffusion panels than can be achieved with surface treatment. The use of sub-surface optical features 108, in some embodiments, also allows for reduced accumulation of contaminants on the surfaces of the light diffusion panel 104, due to planar outer surfaces of the light diffusion panel 104 instead of grooved outer surfaces or the like due to surface treatment.

In the exemplary embodiment shown in FIG. 10, the light diffusion panel 104 including the light source aperture 106 is bordered by an edge surface 110. The edge surface 110 is shown as a vertical wall of the light diffusion panel 104 surrounding the centrally located light source aperture 106. The light diffusion panel 104 further includes an emission surface 112, which is shown in a plan view in FIG. 8 and is shown as being perpendicular to the edge surface 110 in FIG. 10. The emission surface 112 includes a first emission surface section 112a, which is illustrated as the central square section bordered by the four light source apertures 106 in the embodiment of FIG. 8. The emission surface 112 also includes a second emission surface section 112b, which is illustrated as the bordering outer section positioned between the light source apertures 106 and the outer periphery 114 of the light diffusion panel 104 in the embodiment of FIG. 8. Although the optical features 108 are illustrated similarly in both the first and second emission surface sections 112a, 112b, other embodiments contemplated herein include different optical features 108 between the emission surface sections 112a, 112b.

As shown in FIG. 10, some embodiments include a reflective surface 116 disposed in the housing 102 adjacent the light diffusion panel 104 (illustrated as being above the light diffusion panel 104). This reflective surface 116 is positioned opposite the light diffusion panel 104 from the emission surface 112. The reflective surface 116 may be affixed to the housing 102, a surface of the housing 102 itself, affixed to the light diffusion panel 104, trapped between the housing 102 and the light diffusion panel 104, or the like. The reflective surface 116 may be included to improve system efficacy and may be applied onto or adjacent to the surface of the light diffusion panel 104 that is opposite the emission surface 112. The reflective surface 116 may be a reflector, diffuse reflective material, specular reflective material, or the like.

Also shown in FIG. 10, a plurality of light sources 118 projects light 120 into the light diffusion panel 104 through the edge surface 110 of the light diffusion panel 104. At least one light source 118 is mounted in relatively close proximity to an edge (such as the edge surface 110) of the light diffusion panel 104 in such a way that the light 120 is at least partially transmitted into the light diffusion panel 104. The plurality of light sources 118 includes a first light source 118a (shown on the left in FIG. 10) projecting light 120a into the light diffusion panel 104 and out of the light diffusion panel 104 through the first emission surface section 112a. The plurality of light sources 118 also includes a second light source 118b (shown on the right in FIG. 10) projecting light 120b into the light diffusion panel 104 and out of the light diffusion panel 104 through the second emission surface section 112b. In some embodiments, the plurality of light sources 118 includes multiple light emitting diodes (LEDs). The LEDs 118 may be brighter on the first emission surface section 112a side than on the second emission surface section 112b side or vice versa. In other embodiments, the brightness is controlled with features of the light diffusion panel 104 in addition to, or as an alternative to, the difference in LED brightness.

In some embodiments, the plurality of light sources 118 includes the first light source 118a configured to emit white light and the second light source 118b configured to emit light of a particular color (red, blue, green, or the like) or vice versa. In some embodiments, the plurality of light sources 118 includes more than one first light source 118a and more than one second light source 118b. In such embodiments, some of the first light sources 118a may be configured to emit white light while others of the first light sources 118a may be configured to emit light of a particular color. Likewise, some of the second light sources 118b may be configured to emit white light while others of the second light sources 118b may be configured to emit light of a particular color. In some embodiments, however, all of the first light sources 118a may be configured to emit white light and all of the second light sources 118b may be configured to emit light of a particular color or vice versa. The light sources 118 configured to emit light of a particular color in any of the above embodiments may include some light sources 118 configured to emit one particular color (such as red), other light sources 118 configured to emit another particular color (such as blue), and so on.

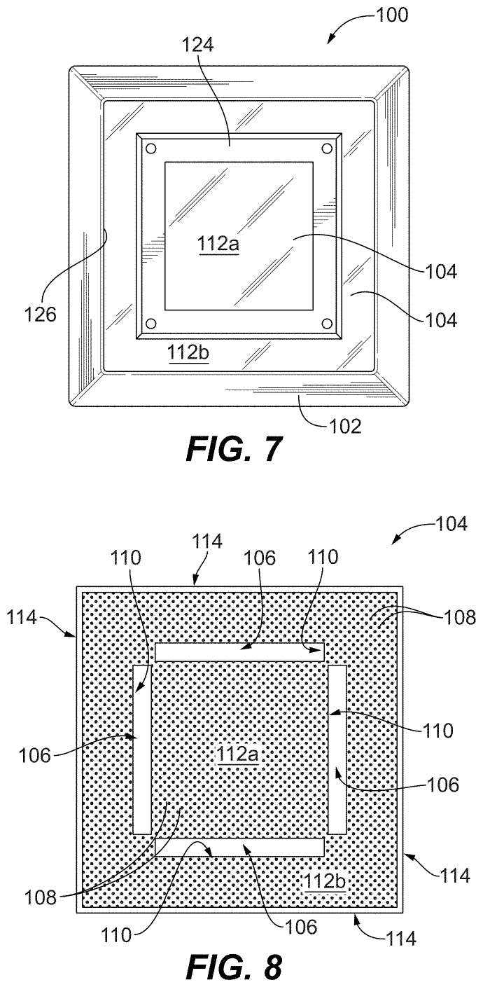

Also shown in the embodiment of FIG. 10, the plurality of light sources 118 are disposed in the light source aperture 106. The light sources 118 are mounted to a frame 122 which is coupled to the housing 102. The frame 122 can also include a support flange 124 which supports the light diffusion panel 104 alone or in combination with an outer edge 126 of the housing 102 (shown in FIGS. 2 and 7). In some embodiments, the frame 122 includes one or more sensors 128. The sensors 128 may include, for instance, light detection and ranging (LiDAR) sensors, ultrasonic sensors, induction coil sensors, weight sensors, motion sensors, temperature sensors, or the like. Additionally or alternatively, the luminaire 100 may include one or more actuators, one or more electronic interfaces, one or more mechanical interfaces, or the like.

The light diffusion panel 104 of FIG. 10 may also be configured such that at least some of the light 120b is reflected internally until it passes through the outer periphery 114 of the light diffusion panel 104. Depending on the shape of the housing 102, this outer periphery light 120b can function as a recessed lighting for the luminaire 100 in some embodiments.

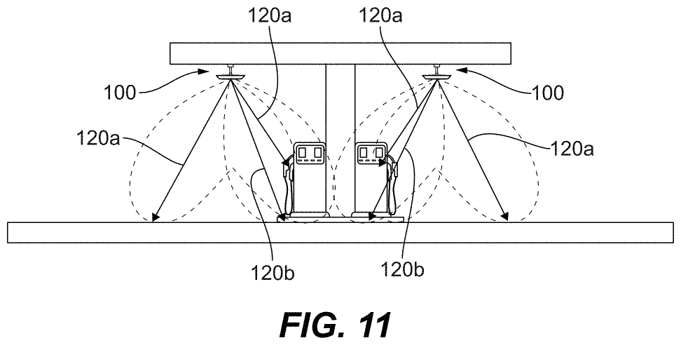

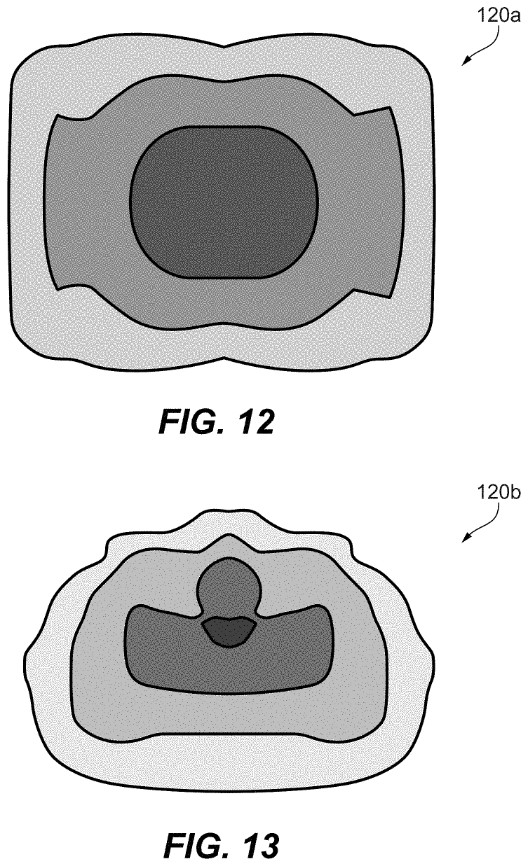

As shown in FIGS. 11-13, the luminaire 100 can be configured to spread light 120 in more than one pattern due at least in part to the two emission surface sections 112a, 112b. For example, the center emission surface section 112a can create a rectangular light emission pattern (as shown in FIG. 12) for general area lighting while the perimeter emission surface section 112b can create an asymmetric light emission pattern (as shown in FIG. 13) for illuminating a particular location. In other embodiments, the light emission patterns are achievable by illuminating different light sources 118 of the plurality of light sources 118. The luminaire 100 can also be configured to adjust or alter the brightness, color, and/or temperature of the light 120 for signaling or adequate illumination purposes.

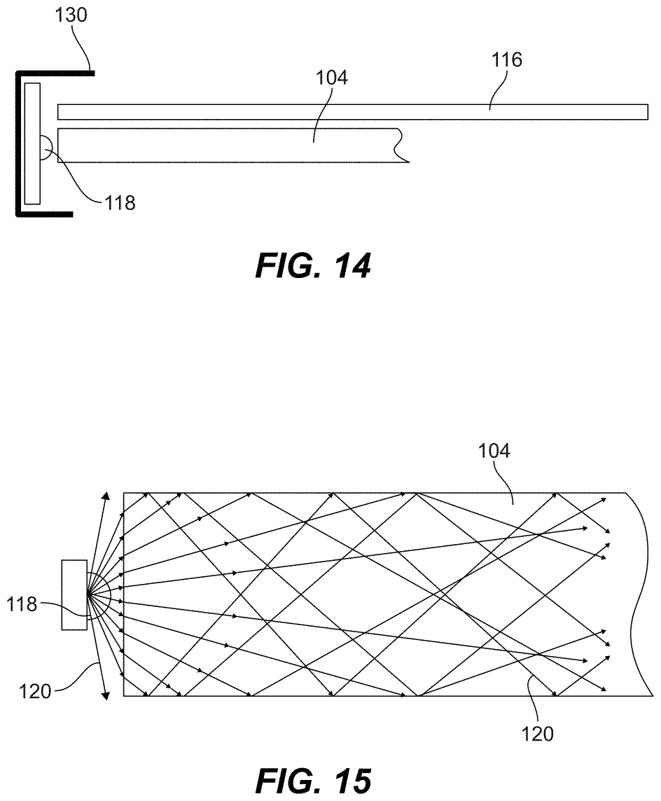

Regardless of whether the light source 118 is located in an aperture or adjacent an outer edge of a light diffusion panel 104, the light source 118 projects light 120 into the light diffusion panel 104 to then be emitted through an emission surface 112. As shown in FIG. 14, some embodiments of the luminaire 100 further include a heat sink 130 to dissipate heat that is produced by the one or more light sources 118.

With reference to FIG. 15, at least some of the light 120 projected from the light source 118 may escape around the periphery of the light. At least some of the light 120 that is projected into the light diffusion panel 104 reflects off of interior surfaces of the light diffusion panel 104 at an angle that exceeds a critical angle. This results in internal reflection of the light 120 within the light diffusion panel 104. The portions of the light diffusion panel 104 having no optical features 108 produce the most internal reflection of the light 120. These portions may be referred to as transition zones. The transition zones are typically unable to efficiently emit light and are, therefore, used to project the light into the emission surface sections 112.

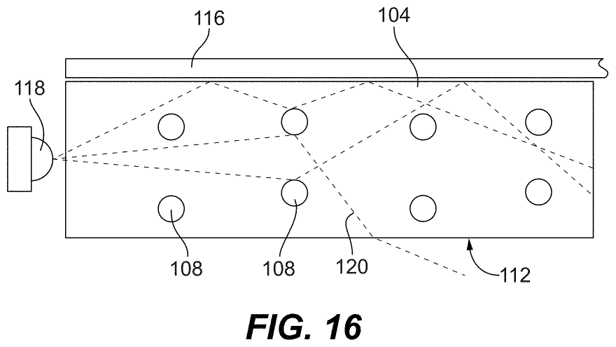

As shown in FIG. 16, at least some of the light 120 encounters one or more optical features 108 (shown as a sub-surface optical feature). The light 120 leaves the light source 118, travels through the transition zone of the light diffusion panel 104, and projects onto or through the optical feature 108. In the embodiment shown in FIG. 16, the light 120 is projected out of the light diffusion panel 104 into the sub-surface optical feature 108 and is reflected off of the reflective surface 116 back into the light diffusion panel 104. Also shown in the embodiment of FIG. 16, the light 120 is projected into a sub-surface optical feature 108 and toward the emission surface 112. Since the light 120 is at an angle of incidence that is much more aggressive due to the optical feature 108, the light 120 is able to escape the light diffusion panel 104 through the emission surface 112 instead of internally reflecting.

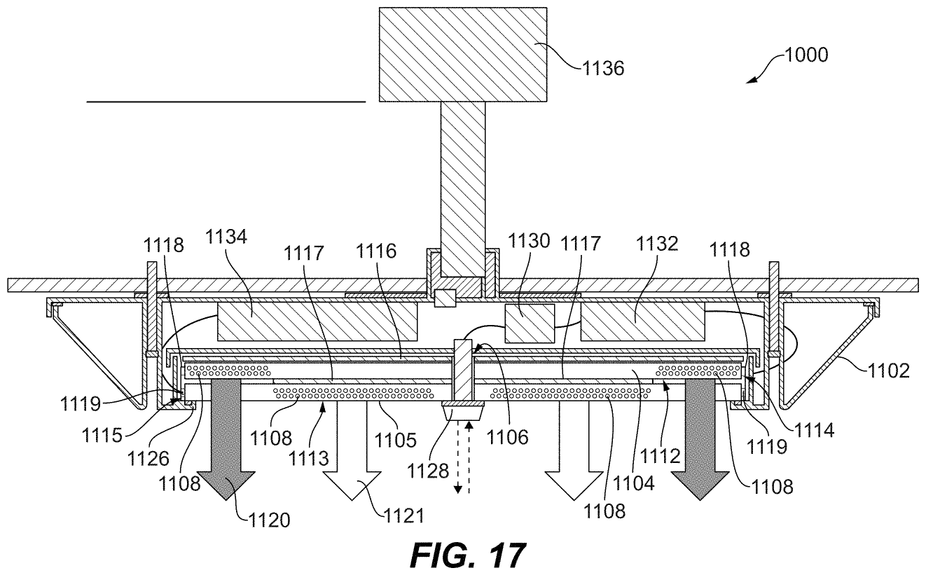

As shown in FIG. 17, another embodiment of a luminaire 1000 is shown. Many components of the luminaire 1000 are similar or identical to the luminaire 100 discussed above. As such, like components will have the same reference number as discussed above, but increased by a value of one thousand.

The luminaire 1000 includes a housing 1102 that at least partially contains a first light diffusion panel 1104 and a second light diffusion panel 1105, which may cooperate to form a multi-element light guide assembly (MLGA). In the illustrated embodiment of FIG. 17, the light diffusion panels 1104, 1105 are shown in a stacked configuration. The two or more light diffusion panels 1104, 1105 may be substantially parallel to each other.

In some embodiments, each of the light diffusion panels 1104, 1105 includes an aperture 1106 defined therein. The apertures 1106 receive, in the illustrated embodiment, one or more sensors 1128.

The light diffusion panels 1104, 1105 include sub-surface laser-engraved or otherwise manufactured optical features 1108. The optical features 1108 are shown as a series of bubbles or voids in FIG. 17. As discussed above, the optical features 1108 may be in the form of surface treatment of the light diffusion panels 1104, 1105 or may be within the light diffusion panels 1104, 1105.

The first light diffusion panel 1104 further includes a first panel emission surface 1112. Likewise, the second light diffusion panel 1105 further includes a second panel emission surface 1113. Each of the emission surfaces 1112, 1113 may have one or more emission sections, but the illustrated embodiment in FIG. 17 shows only one continuous emission surface 1112, 1113 for each light diffusion panel 1104, 1105.

The first light diffusion panel 1104 also includes a first panel outer periphery 1114. Similarly, the second light diffusion panel 1105 also includes a second panel outer periphery 1115. The light diffusion panels 1104, 1105 are shown in the illustrated embodiment as rectangular, but other shapes are also contemplated herein.

Also shown in FIG. 17, a first reflective surface 1116 is disposed in the housing 1102 adjacent the first light diffusion panel 1104. The first reflective surface 1116 is disposed opposite the first light diffusion panel 1104 from the first panel emission surface 1112. The first reflective surface 1116 may be affixed to the housing 1102, a surface of the housing 1102 itself, affixed to the first light diffusion panel 1104, trapped between the housing 1102 and the first light diffusion panel 1104, or the like. In the illustrated embodiment, the first reflective surface 1116 covers substantially all (or completely all) of the side of the first light diffusion panel 1104 opposite the first light diffusion panel 1104 from the first panel emission surface 1112.

A second reflective surface 1117 is disposed in the housing 1102 adjacent the second light diffusion panel 1105. The second reflective surface 1117 is disposed opposite the second light diffusion panel 1105 from the second panel emission surface 1113. The second reflective surface 1117 may be affixed to the second light diffusion panel 1105, affixed to the first light diffusion panel 1104, trapped between the light diffusion panels 1104, 1105, or the like. In the illustrated embodiment, the second reflective surface 1117 covers a majority of the side of the second light diffusion panel 1105 opposite the second light diffusion panel 1105 from the second panel emission surface 1113. Also in the illustrated embodiment, the second reflective surface 1117 does not cover the entire side of the second light diffusion panel 1105. Particularly, the illustrated embodiment includes a border area around the second light diffusion panel 1105 adjacent the second panel outer periphery 1115 that is without the second reflective surface 1117.

Also shown in FIG. 17, a plurality of first panel light sources 1118 projects light 1120 into the first light diffusion panel 1104 through the first panel outer periphery 1114. The plurality of first panel light sources 1118 is illustrated as being light sources that are configured to emit light of one or more particular colors. Particularly, the illustrated embodiment in FIG. 17 includes red, blue, and green light sources 1118. Of course, other embodiments include additional or alternative light sources 1118. The first panel light sources 1118 project light 1120 into the first light diffusion panel 1104 and out of the first light diffusion panel 1104 through the first panel emission surface 1112.

The luminaire 1000 further includes a plurality of second panel light sources 1119. Each second panel light source 1119 projects light 1121 into the second light diffusion panel 1105 through the second panel outer periphery 1115. The plurality of second panel light sources 1119 is illustrated as being light sources that are configured to emit white light. Of course, other embodiments include additional or alternative light sources 1119. The second panel light sources 1119 project light 1121 into the second light diffusion pane 1105 and out of the second light diffusion panel 1105 through the second panel emission surface 1112.

Because of the stacked configuration of the light diffusion panels 1104, 1105, the light 1120 that passes through the first panel emission surface 1112 also passes through the second light diffusion panel 1105 and through the second panel emission surface 1112. The total output of light 1120, 1121 from the luminaire 1000, therefore, is approximately the aggregate of the two or more light diffusion panels 1104, 1105. In such embodiments, the luminaire 1000 may include a reduced size or shape due to the size/shape no longer being limited by the number of the plurality of light sources 118a, 118b that can be arranged in a single plane.

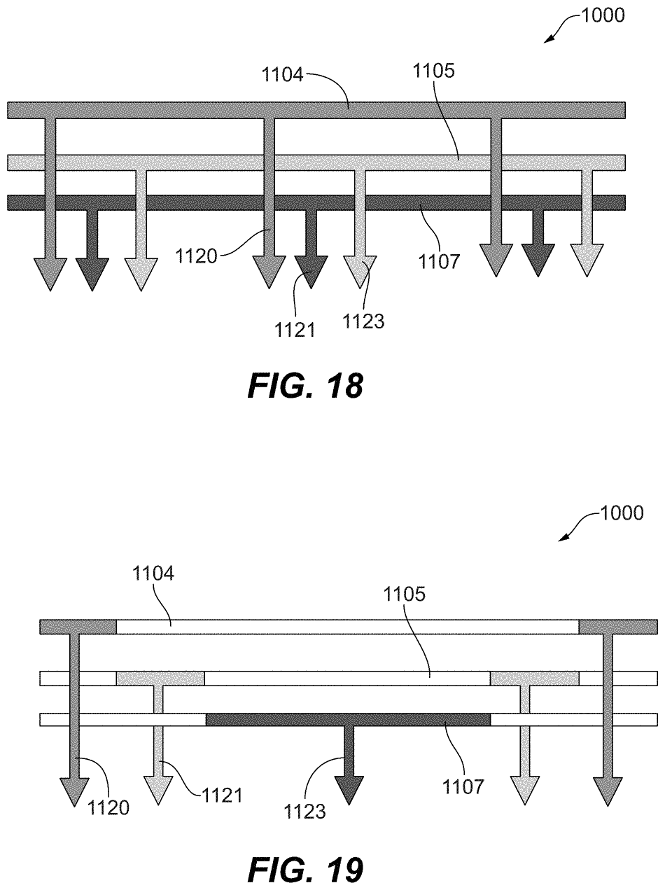

The positioning, size, and shape of the second reflective surface 1117 can impact how much of the light 1120 is able to pass through the second light diffusion panel 1105 and where on the second light diffusion panel 1105 the light 1120 is able to pass through. In some embodiments, the light 1120 is emitted at least partially (or even substantially) comingled with at least some of the light 1121 as the light 1120, 1121 projects thorough the second light diffusion panel 1105 and beyond the second panel emission surface 1113 (as shown in FIG. 18). In other embodiments, the second reflective surface 1117 is positioned such that the light 1120 is emitted substantially separately from the light 1121 through and beyond the second panel emission surface 1113.

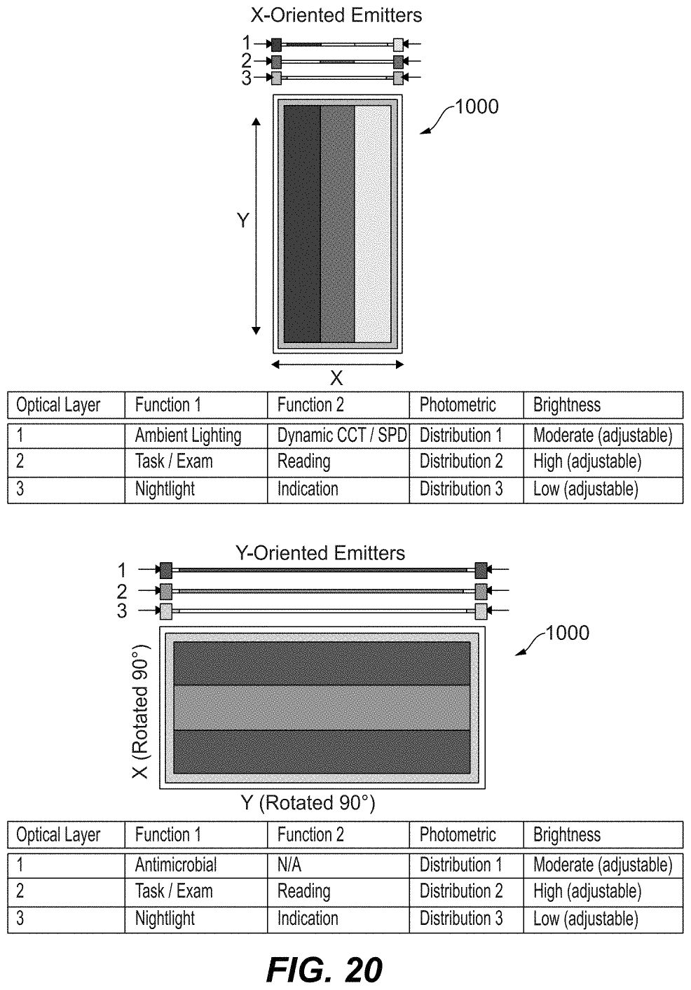

Additionally or alternatively, the location, size, and shape of each section of optical features 108 in the plurality of light diffusion panels 1104, 1105, 1107 can allow light 1120, 1121, 1123 to transmit beyond the luminaire 1000 with minimal interference with each other (as shown in FIGS. 19 and 20). This capability allows for multiple functions including, for instance, photometric distribution, task lighting, indicator lighting, antimicrobial effects, or the like. This capacity also allows for multiple lighting characteristics including, for instance, varied spectral power, correlated color temperature, color quality, intensity, or the like.

In the illustrated embodiment of FIG. 17, the first and second panel light sources 1118, 1119 are mounted to the housing 1102, although some embodiments could have the light sources 1118, 1119 affixed to the respective light diffusion panels 1104, 1105. Further, the first and second light diffusion panels 1104, 1105 are retained in the housing 1102 in the illustrated embodiment by an outer edge 1126 of the housing 1102.

The sensor 1128 is illustrated as being mounted to a portion of the housing 1102, but it, too, could be mounted to one or both of the light diffusion panels 1104, 1105. In the embodiment of FIG. 17, the housing 1102 further includes a control module 1130, a first panel light source driver 1132, and a second panel light source driver 1134 disposed therein. These electrical components of the luminaire 1000 may be powered by a battery (not shown) disposed on or in the housing 1102, or they may be powered with mains electricity routed into the housing 1102 through a junction box 1136. The junction box 1136 is illustrated as being disposed above a canopy wall 1138 of a structure (such as a ceiling of a canopy).

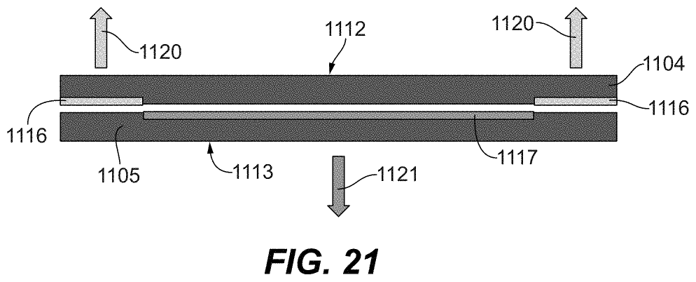

As shown in FIG. 21, the first reflective surface 116 can be disposed between the first light diffusion panel 1104 and the second light diffusion panel 1105 such that the first panel emission surface 1112 is an upper surface of the first light diffusion panel 1104. In this illustrated embodiment, the light 1120 is projected into the first light diffusion panel 1104 through the first panel outer periphery 1114 and upwardly out of the first panel emission surface 1112. This embodiment may be used to provide, for instance, recessed lighting for the luminaire 1000.

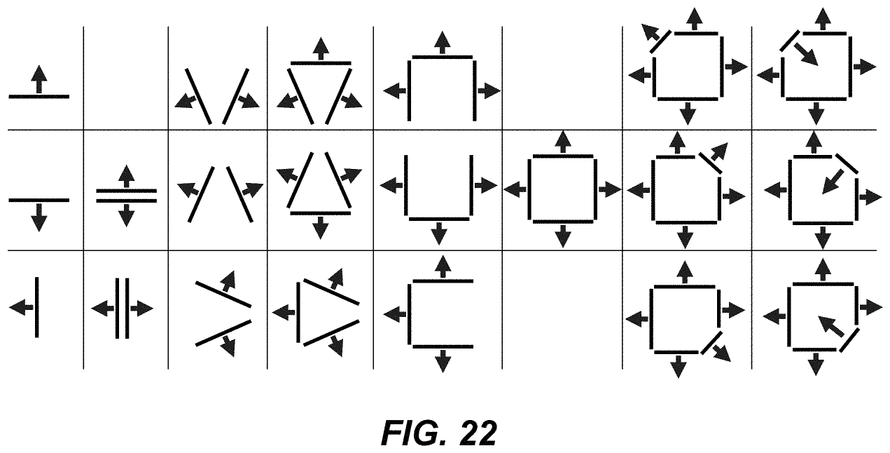

Turning now to FIG. 22, although the luminaires 100, 1000 have been described above as relating to a canopy mounting location, the luminaires could also be mounted to a vertical wall of a structure as a wall sconce, hung from a ceiling as a pendant, mounted to a light pole, or the like. The luminaires could direct light of various characteristics in multiple directions as desired. As shown in FIG. 22, a plurality of light diffusion panels can cooperate to direct light in a variety of directions. Although only two-dimensional layouts of the light diffusion panels are shown in FIG. 22, these layouts are only meant to be examples. The light diffusion panels could be arranged in a three-dimensional layout to form a cube, pyramid, cylinder, or the like. As shown in some of the examples in FIG. 22, some of the layouts of the light diffusion panels may additionally or alternatively illuminate an interior space of the luminaire assembly.

The luminaires 100, 1000 discussed herein are capable of mixing light of various characteristics. Blue light can be combined with white light to create a white light having a different temperature than what might be accomplished by the white light alone. For instance, light with a temperature of 6500 K can be emitted from the first light diffusion panel 1104 of the luminaire 1000, and light with a temperature of 2700 K can be emitted from the second light diffusion panel 1105. These lights may be combined, may illuminate one at a time, or may do both in some sequence to create light having varying characteristics. Some embodiments may combine white light with high-intensity narrow-spectrum (HINS) light to provide adequate visual lighting that has the added benefit of killing at least some bacteria in the area. The constructions discussed above allow for one or more of the light sources to be powered by a battery backup system in case of emergencies. Different guide media can be used to vary the effect of the different light sources. Non-luminous or transmissive materials can be used for the housing or other components. Similarly, volumetric diffuse materials can be used for one or more components described above.

The attached Figures, additional disclosure images (in the form of PowerPoint presentations), and the above description are simply example embodiments of the apparatuses, systems, and methods contemplated by the Applicant.

What is claimed is:

1. A luminaire comprising:
a housing;
a light diffusion panel positioned in the housing, the light diffusion panel including
a light source aperture defined therein;
an edge surface bounding the light source aperture;
a plurality of sub-surface optical features disposed within the light diffusion panel; and
an emission surface, the emission surface including an emission surface section; and
a light source projecting light into the light diffusion panel through the edge surface of the light diffusion panel to interact with the plurality of sub-surface optical features and exit the light diffusion panel through the emission surface section.

2. The luminaire of claim 1, wherein
the light source aperture extends completely through a thickness of the light diffusion panel extending from the emission surface to a side of the light diffusion panel opposite the emission surface.

3. The luminaire of claim 2, wherein
the sub-surface optical features are disposed within the light diffusion panel between the emission surface section and the side of the light diffusion panel opposite the emission surface.

4. The luminaire of claim 2, wherein
the sub-surface optical features are located at varying depths between the emission surface and the side of the light diffusion panel opposite the emission surface.

5. The luminaire of claim 2, further comprising
a reflective surface disposed on the side of the light diffusion panel opposite the panel emission surface, the reflective surface configured to reflect light back into the light diffusion panel.

6. The luminaire of claim 2, further comprising
a frame coupled to the housing, a portion of the frame extending through the light source aperture.

7. The luminaire of claim 6, wherein
the light source is coupled to the frame.

8. The luminaire of claim 6, further comprising
a support flange coupled to the frame, the support flange engaging the side of the light diffusion panel opposite the emission surface.

9. The luminaire of claim 1, wherein
the sub-surface optical features include voids in the light diffusion panel.

10. The luminaire of claim 1, wherein
the sub-surface optical features are arranged in an irregular pattern within the light diffusion panel.

11. The luminaire of claim 1, wherein
the light source is a first light source;
the plurality of sub-surface optical features includes a first group of sub-surface optical features and a second group of sub-surface optical features, the second group of sub-surface optical features positioned on an opposite side of the light source aperture from the first group of sub-surface optical features;
the emission surface section is a first emission surface section;
the first light source projects light into the light diffusion panel through the edge surface of the light diffusion panel to interact with the first group of sub-surface optical features and exit the light diffusion panel through the first emission surface section;
the emission surface further includes a second emission surface section, the second emission surface section positioned on an opposite side of the light source aperture from the first emission surface section; and
a second light source projects light into the light diffusion panel through the edge surface of the light diffusion panel to interact with the second group of sub-surface optical features and exit the light diffusion panel through the second emission surface section.

12. A luminaire comprising:
a housing;
a light diffusion panel positioned in the housing, the light diffusion panel including
a plurality of sub-surface optical features disposed therein;
a panel outer periphery; and
a panel emission surface; and
at least one light source projecting light into the light diffusion panel through the panel outer periphery, into one or more of the sub-surface optical features, and out of the light diffusion panel through the panel emission surface.

13. The luminaire of claim 12, wherein
the sub-surface optical features include voids in the light diffusion panel.

14. The luminaire of claim 12, further comprising
a second light diffusion panel positioned in the housing, the second light diffusion panel including
a second plurality of sub-surface optical features disposed therein;
a second panel outer periphery; and
a second panel emission surface;
a second reflective surface disposed on a side of the second light diffusion panel opposite the second panel emission surface and between the light diffusion panel and the second light diffusion panel;
at least one second light source projecting light into the second light diffusion panel through the second panel outer periphery, into one or more of the second plurality of sub-surface optical features, and out of the second light diffusion panel through the second panel emission surface; and
wherein
the light diffusion panel is a first light diffusion panel;
the plurality of sub-surface optical features is a first plurality of sub-surface optical features;
the panel outer periphery is a first panel outer periphery;
the panel emission surface is a first panel emission surface; and
the at least one light source is at least one first light source.

15. The luminaire of claim 14, wherein
the first panel emission surface faces a first direction; and
the second panel emission surface faces a second direction opposite the first direction.

16. The luminaire of claim 14, wherein
the first panel emission surface faces a direction; and
the second panel emission surface faces the direction.

17. The luminaire of claim 16, wherein
the first panel emission surface is disposed between at least a portion of the housing and the second light diffusion panel.

18. The luminaire of claim 17, wherein
light exiting the first panel emission surface subsequently passes through at least a portion of the second light diffusion panel.

19. The luminaire of claim 16, wherein
the first light diffusion panel and the second light diffusion panel are in a stacked arrangement.

20. The luminaire of claim 12, further comprising
a reflective surface disposed on a side of the light diffusion panel opposite the panel emission surface.
